(19) United States
(12) Patent Application Publication
(10) Pub. No.: US 2013/0052926 A1
(43) Pub. Date: Feb. 28, 2013

(54) COIN DEPOSITING AND DISPENSING APPARATUS, CONTROL METHOD THEREOF

(71) Applicant: Yuki Taniike, Shizuoka-ken (JP)

(72) Inventor: Yuki Taniike, Shizuoka-ken (JP)

(73) Assignee: TOSHIBA TEC KABUSHIKI KAISHA, Tokyo (JP)

(21) Appl. No.: 13/590,356

(22) Filed: Aug. 21, 2012

(30) Foreign Application Priority Data
Aug. 26, 2011 (JP) 2011-185305

(51) Int. Cl. G07D 9/00; G07D 5/00

(52) U.S. Cl. 453/58

(57) ABSTRACT

A coin depositing and dispensing apparatus comprises a coin selecting unit configured to select the type of the coin by kind according to the shape of the deposited coin, a plurality of coin type accepting storehouses configured to accept the coin selected by the coin selecting unit according to the type of coin, an accepting number detecting unit configured to detect the number of the coin accepted in each coin type accepting storehouse and a balance counting unit configured to count the balance according to the detecting result by the accepting number detecting unit.

### CROSS-REFERENCE TO RELATED APPLICATION

This application is based upon and claims the benefit of priority from Japanese Patent Application No. 2011-185305, filed Aug. 26, 2011, the entire contents of which are incorporated herein by reference.

### FIELD

The embodiments described herein relate to a coin depositing and dispensing apparatus, a control method thereof.

### BACKGROUND

In recent years, a coin depositing and dispensing apparatus becomes widely used at a retail level. The apparatus stores a coin in a coin storage according to the type of the coin, and dispenses the coin as change from a coin discharge port upon request of a POS terminal or an ECR.

The apparatus can be arranged on a so-called self-checkout machine which can be paid (counted) by customers themselves at times.

### DESCRIPTION OF THE DRAWINGS

FIG. 1 is an appearance perspective view showing a coin depositing and dispensing apparatus of embodiments.

FIG. 2 is a plane graph showing a coin depositing and dispensing unit.

FIG. 3 is a summary composition block diagram showing a control system of the depositing and dispensing apparatus.

FIG. 4 is a longitudinal sectional view showing a coin selecting part and a coin accepting part.

FIG. 5 is a process flowchart of the embodiments.

### DETAILED DESCRIPTION

According to one embodiment, a coin depositing and dispensing apparatus comprises a coin selecting unit configured to select the type of the coin by kind according to the shape of the deposited coin, a plurality of coin type accepting storehouses configured to accept the coin selected by the coin selecting unit according to the type of coin, an accepting number detecting unit configured to detect the number of the coin accepted in each coin type accepting storehouse and a balance counting unit configured to count the balance according to the detecting result by the accepting number detecting unit.

The coin depositing and dispensing apparatus of the embodiments will be described in detail hereinafter in reference to the accompanying drawings.

The embodiment is an application example aimed at the coin depositing and dispensing apparatus (the automatic change machine), wherein the coin depositing and dispensing apparatus carries the coin deposited from a coin charge port, selects and accepts the coin into a coin accepting part according to the type of the coin by the coin selecting part, and discharges the coin on the basis of a coin discharging instruction according to the type of coin.

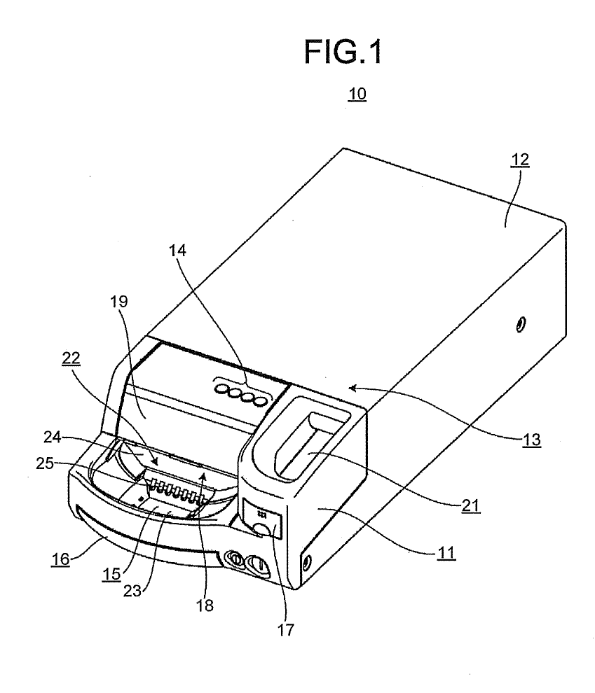

FIG. 1 is an appearance perspective view showing a coin depositing and dispensing apparatus of embodiments.

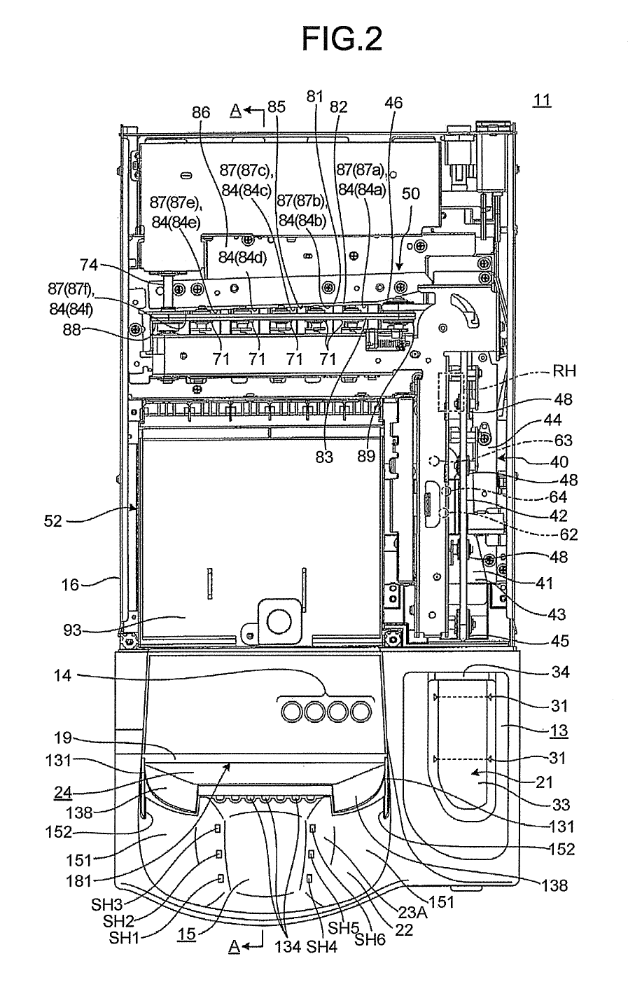

FIG. 2 is a plane graph showing a coin depositing and dispensing unit.

As shown in FIG. 1, the coin depositing and dispensing apparatus 10 is basically provided with a coin depositing and dispensing unit 11 for discharging and charging the coin, and an accepting box 12 for accepting and keeping the coin withdrawn out of the coin depositing and dispensing unit 11.

As shown in FIG. 1 and FIG. 2, the coin depositing and dispensing unit 11 is provided with a coin accepting part 13 arranged at the front of the coin depositing and dispensing apparatus 10 to accept the deposited coin, an operating panel 14 comprising a plurality of operation components configured to perform various operation, and a coin discharge part 15 configured to dispense and keep the coin.

Furthermore, as shown in FIG. 1, the coin depositing and dispensing unit 11 is further provided with: a handle withdrawing part 16, arranged under the coin discharge part 15, configured to withdraw a recovery cross-bar which supports a recovery bag installing part supporting a discharge recovery bag to the front from the accepting box 12; and a reject box 17, kept on the coin depositing and dispensing unit 11 in a withdrawable way, so as to keep the dispended coin such as a deformed coin and the like; a coin discharge port 18, configured to dispense the coin; and an outer cover 19, configured to form into the coin discharge port 18.

In the structure, the coin accepting part 13 is provided with a coin charge port 21 configured to deposit the coin. The coin charge port 21 allows the plurality of coins to be deposited at the same time. A plurality of groups of depositing sensors 31 which are configured to convey out photoelectric detection on the deposited coins are arranged on the coin charge port 21.

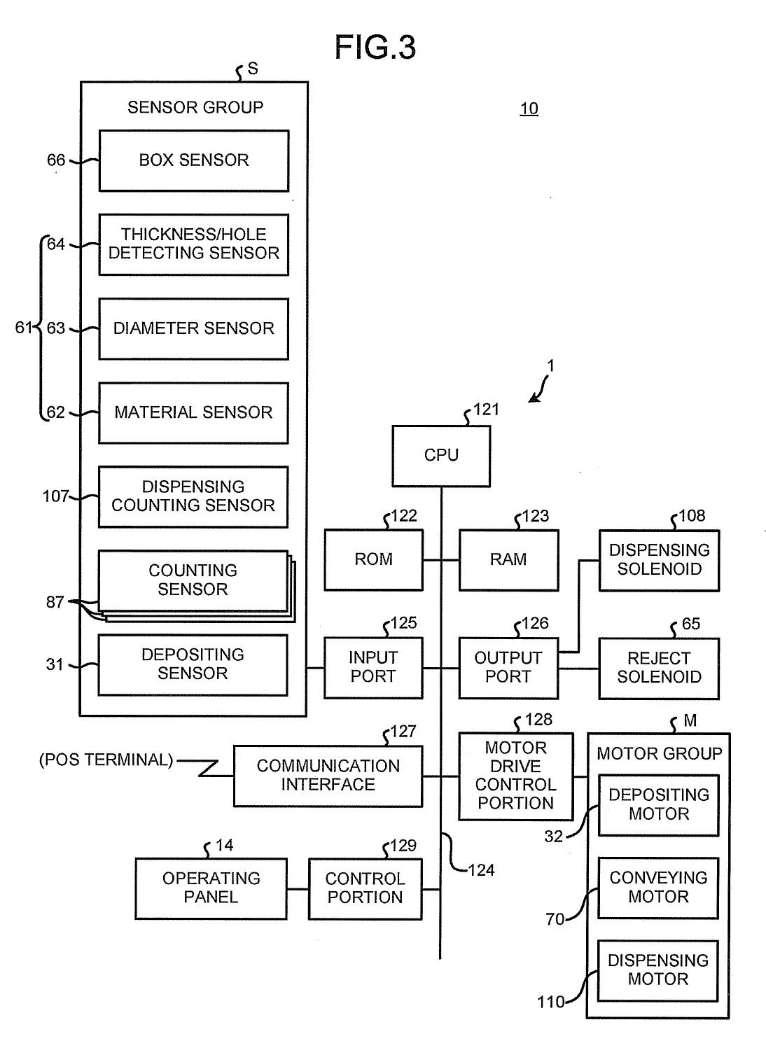

FIG. 3 is a summary composition block diagram showing a control system of the depositing and dispensing apparatus.

Furthermore, a charge conveyor belt 33 is arranged at the bottom of the coin charge port 21, and the charge conveyor belt 33 is driven by a charge motor (in reference to FIG. 3) to rotate, so as to convey the coin into the coin depositing and dispensing apparatus 10. A charge pulley wheel 34 is arranged in the middle of the charge conveyor belt 33, and the charge pulley wheel 34 is configured to separate and transmit the coins conveyed by the charge conveyor belt 33 one by one.

Furthermore, the coin discharge part 15 is provided with a tray part 22 for keeping the disdeposited coin. The bottom of the tray part 22 is provided with a keep part 23 for keeping the coin conveyed by the coin conveying part. The tray part 22 is provided with: a switching component 24, configured to selectively switch a conveying destination of the coin conveyed by the coin conveying part between any one of the keep part 23 or the discharge recovery bag; and a finger inserting preventing part, configured to plug up a gap between the keep part 23 and the switching component 24, so as to prevent the finger from being inserted.

A coin conveying part 40 is arranged at the back of the charge pulley wheel 34.

The coin conveying part 40 is provided with a coin conveying surface 41 and a conveying conveyor belt 42 configured to simultaneously press the coin on the coin conveying surface 41 and convey the coin.

The coin conveying surface 41 is arranged at a downstream side along with the coin conveying direction of the charge conveyor belt 33, and is arranged on a position for accepting the coin conveyed by the charge conveyor belt 33. The coin conveying surface 41 is formed on the upper surface of a conveying base 43. A conveying guiding component 44 is fixed at the right side in the FIG. 2 along with the coin conveying direction of the coin conveying surface 41 on the conveying base 43. The conveying base 43 and the conveying guiding component are made from the metal which is harder than a coin to be conveyed.

The conveying conveyor belt 42 is an endless belt made from the rubber, wherein the cross section thereof is circular. The conveying conveyor belt 42 extends to a selecting conveyor belt 83 used for selecting the coin from the charge conveyor belt 33.

The conveying conveyor belt 42 is arranged above the coin conveying surface 41 and at the position for pressing the coin on the coin conveying surface 41.

The conveying conveyor belt 42 is arranged on a pulley wheel 45 and a pulley wheel 46 corresponding to the pulley wheel 45. The terminal part of the conveying conveyor belt 42 is bended along with the direction which is mainly to be a right angle relative to the selecting conveyor belt 83 by a pair of upper and lower pulley wheels 47 arranged between the pulley wheel 46 and the pulley wheel 45. Therefore, the conveying conveyor belt 42 mainly forms to be L-shaped. The upper and lower pulley wheels 47 are mutually, reversibly and rotatably connected with each other. Furthermore, the inner surface of the conveying conveyor belt 42, which is opposite to the coin conveying surface 41, is dispensed by a plurality of idle pulley wheels 48.

The pulley wheel 46 rotates at a constant speed under a driving power of the conveying motor 70 (in reference to FIG. 3) connected with the selecting conveyor belt 83, and the conveying conveyor belt 42 rotates at a constant speed as well due to the constant-speed rotation of the pulley wheel 46.

The coin conveyed by the charge conveyor belt 33 is clamped by the conveying conveyor belt 42 and the coin conveying surface 41 at the downstream side of the pulley wheel 45, and the coin is pressed on the coin conveying surface 41 and is conveyed under the conveying conveyor belt 42 to reach to a coin selecting part 50.

The conveying guiding component 44 is arranged by the means that the conveying route of the coin conveyed on the charge conveyor belt 33 is not interfered. The conveying guiding component is provided with a first inclined surface which forms into an angle alpha relative to the conveying conveyor belt 42 and a second inclined surface which forms into an angle beta relative to the conveying conveyor belt 42. Furthermore, the relationship between the angle alpha of the first inclined surface and the angle beta of the second inclined surface is as follows: the angle alpha is greater than the angle beta. The second inclined surface is arranged at the downstream side of the coin conveying direction of the first inclined surface. The width of the conveying route of the coin conveyed on the charge conveyor belt 33 is narrowed by the conveying guiding component 44 gradually.

A coin identifying part 61 (in reference to FIG. 3) for identifying the coin is arranged on the position for passing through coin of the coin conveying surface 41 to the upstream side of the coin conveying direction from a discarding hole 33a. The coin identifying part 61 is provided with a material sensor 62 of a first identifying sensor configured to detect the material of the coin, a diameter sensor 63 of a second identifying sensor configured to detect the diameter of the coin, and a thickness/hole detecting sensor 64 of a third identifying sensor configured to detect the thickness of the coin and the existence of the hole. In the three identifying sensors 62, 63 and 64, the material sensor 62 is arranged at the most-upstream side of the coin conveying direction, and the diameter sensor 63 is arranged at the most-downstream side of the coin conveying direction. Furthermore, the thickness/hole detecting sensor 64 is arranged between the material sensor 62 and the diameter sensor 63 along with the coin conveying direction.

Furthermore, the thickness/hole detecting sensor 64 can be replaced by a sensor for detecting the information of the coin except the material and the diameter, such as the sensor for detecting the reflectivity, the concave-convex shape and the like of the coin.

The material sensor 62, the diameter sensor 63, and the thickness/hole detecting sensor 64 form into a magnetic sensor which is provided with a coil, an oscillation circuit connected with the coil, and a rectification circuit connected with the oscillation circuit in the example.

Herein, in the material sensor 62, the diameter sensor 63 and the thickness/hole detecting sensor 64, if the coin is adjacent to the coil forming into the sensors, the impedance of the coil will be changed, and the oscillation level of the oscillation circuit will be changed along therewith. The output waveform of the oscillation circuit is rectified to the waveform corresponding to a digital signal by the rectification circuit, and outputs the waveform to a CPU 121 (in reference to FIG. 3).

The CPU 121 compares the output value with a preset standard coin, i.e. the value of a true coin, so as to judge the true and false of the coin of a detected object (judge whether the coin is the true coin of the standard coin or the false coin of the standard coin or not). In the case that the output value is different from the preset value of the true coin, the CPU 121 judges that the coin is the false coin. The variable quantity of the oscillation level of the oscillation circuit is set to be different according to the material of the coin in the material sensor 62, is set to be different according to the diameter of the coin in the diameter sensor 63, and is set to be different according to the existence of the hole of the coin and the thickness of the coin in the thickness/hole detecting sensor 64.

Furthermore, a coin passing position at the downstream end along with the coin conveying direction of the coin conveying surface 41 forms into an reject hole RH capable of falling off the coin with the maximum diameter, and a part of the reject hole is stopped by an reject stop gate which is not shown in the figures, so that any coin can not be fallen off under this state. The reject stop gate is opened and closed by an reject solenoid 65 (in reference to FIG. 3) to be driven. For example, in the case that the coin is judged to be the false coin, coin detecting information opens the reject gate after a preset schedule time, so that the coin falls off from the reject hole RH. An reject box 17 (in reference to FIG. 1) is arranged under the reject hole RH.

The reject box 17 accepts and receives the coin and the like fallen off from the reject hole. The reject box 17 is dispensing on a dispensing part arranged on a housing of the coin depositing and dispensing unit 11 in a withdrawable way. A box sensor 66 (in reference to FIG. 3) detecting the installing state of the reject box 17 is arranged on the dispensing part.

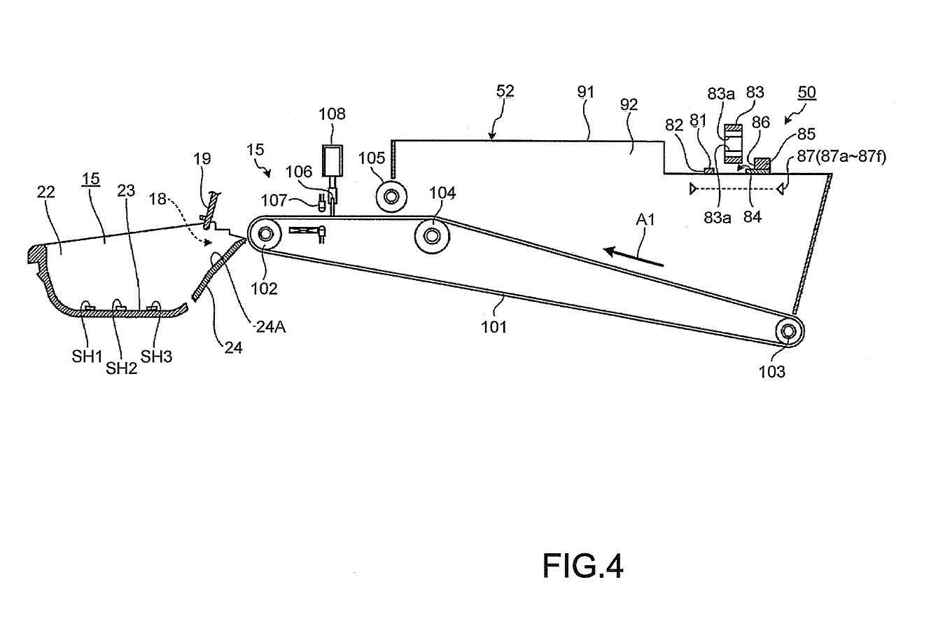

FIG. 4 is a longitudinal sectional view showing a coin selecting part and a coin accepting part.

The coin selecting part 50 is provided with a selecting base 83 of which the upper surface forms into a coin conveying surface 81, and a selecting conveyor belt 83 pressing the coin on the coin conveying surface 81 and conveying the coin.

The coin conveying surface 81 extends towards the left direction and the right direction in FIG. 2 with an approximate right angle relative to the coin conveying surface 41, and the coin conveying surface which is L-shaped from the quarter view on the whole is formed by the coin conveying surface 81 and the coin conveying surface 41.

The selecting base 82 is provided with selecting holes 84a, 84b, 84v, 85d, 84e and 84f penetrating through the coin conveying surface 81 and corresponding to the type of the coin in the manner that the width size of the hole is sequentially enlarged towards the downstream of the coin conveying direction.

The six selecting holes 84a, 84b, 84v, 85d, 84e and 84f are set corresponding to 1 yen, 50 yen, 5 yen, 100 yen, 10 yen and 500 yen from left to right in FIG. 2. That is to say, the 500 yen selecting hole 84f taken as the highest coin type is arranged at the leftmost end among the selecting holes 84a, 84b, 84v, 85d, 84e and 84f. In order to be convenient to explain, the selecting holes are taken as selecting holes 84 in the case that the selecting holes 84a, 84b, 84v, 85d, 84e and 84f do not need necessarily distinguishing hereinafter.

In the embodiment, the adjoining selecting holes 84 along with the coin selecting and conveying direction are formed by mutual continuation, seen from the appearance, one hole is formed. When the coin selecting part 50 carries the coin to reach to the selecting holes with preset widths, the coin falls off to the coin accepting part 52. Herein, the coin accepting part 52 is provided with the plurality of coin type accepting storehouses accepting the coin according to the type of the coin.

Furthermore, a reference component 85 is fixed on the selecting base 82, and a reference plane 86 is formed on the reference component 85. The reference plane 86 supports the side face of the coin, the side face of the coin leans against the reference plane 86, and the coin is conveyed, so that the selecting holes 84 exactly select the coin. Furthermore, relative to each selecting hole 84a, 84b, 84v, 85d, 84e and 84f, counting sensors 87a, 87b, 87c, 87d, 87e and 87f (in reference to FIG. 2) taken as the coin accepting and detecting unit to detect the fallen coin are arranged.

Above the coin conveying surface 81, along with the position that the coin is pressed on the coin conveying surface 81, the selecting conveyor belt 83 is arranged. The selecting conveyor belt 83 is an endless belt made from the rubber, and a belt tooth conveyor belt of which the inner periphery forms into a plurality of teeth 83a.

The selecting conveyor belt 83 is suspended on a pulley wheel 88 and a pulley wheel 89 corresponding to the pulley wheel 88.

The pulley wheel 88 and the pulley wheel 89 are pulley wheels with teeth of which the outer periphery forms into a plurality of teeth meshed with the teeth 83a of the selecting conveyor belt 83.

The pulley wheel 88 is a driving pulley wheel, which is arranged on the selecting hole 84f for selecting the coin with the highest coin (500 yen). The pulley wheel 88 rotates at a constant speed by a drive force transmitted by the conveying motor 70 (in reference to FIG. 3), and the selecting conveyor belt 83 rotates at a constant speed due to the constant-speed rotation of the pulley wheel 88.

The pulley wheel 89 is a driven pulley wheel, which is arranged at the upstream side along with the coin conveying direction of all the selecting holes 84. A pulley wheel 46 is arranged on the pulley wheel 89 and the coin conveying part 40 which is coaxially and fixedly arranged on the pulley wheel 89. Furthermore, the inner surface of the selecting conveyor belt 83, which is opposite to the coin conveying surface 81, is supported by a plurality of idle pulley wheels 71. Accordingly, in the case that the selecting conveyor belt 83 is meshed with the pulley wheel 88 and the pulley wheel 89, when the pulley wheel 88 rotates at a constant speed under the drive of the conveying motor 70, the selecting conveyor belt 83 rotates at a constant speed as well. Furthermore, the pulley wheel 46 fixed on the pulley wheel 89 also rotates at a constant speed along with the linkage of the pulley wheel 89, so that the selecting conveyor belt 83 can transmit a fixed drive force to the conveying conveyor belt 42, to be capable of preferably conveying the coin.

The selecting conveyor belt 83 and the reference plane 86 are arranged in the manner that the two get more and more adjacent to each other along with the downstream of the coin conveying direction, therefore, the selecting conveyor belt 83 presses the coin on the reference plane 86 and carries the coin. Furthermore, the cross section of the selecting conveyor belt 83 is rectangular on the whole, compared with the conveyor belt with a circular cross section, the selecting conveyor belt 83 contacts a large area of the conveyed coin. Therefore, the selecting conveyor belt 8 contacts the coin at a large area when pressing the coin on the coin conveying surface 81 and conveying the coin, so as to be capable of conveying the coin more exactly.

As shown in FIG. 2 and FIG. 4, the coin accepting part 52 is arranged on the position which accepts the coin fallen off from the selecting holes 84, so as to accept the fallen coin according to the type of the coin. Coin type accepting rooms 92 divided by space plates 91 are arranged on the coin accepting part 52. Each accepting room 92 is communicated with the corresponding holes 84. The upper surfaces of the accepting rooms 92 are provided with openings; and the openings on the upper surfaces of the accepting room 92 are covered by covers 93.

As shown in FIG. 4, the coin discharge part 15 is provided with discharge conveyor belts 101 arranged at the bottom of each accepting room 92. The discharge conveyor belts 101 are suspended on a pulley wheel 102 and a pulley wheel 103. The pulley wheel 102 is a driving pulley wheel, and the pulley wheel 103 is a driven pulley wheel. Furthermore, the discharge conveyor belts 101 are supported by idle pulley wheels 104.

The pulley wheel 102 is driven by a dispensing motor 110 (in reference to FIG. 3) to rotate, so that the discharge conveyor belts 101 rotate. The discharge conveyor belts 101 along with the direction shown by an arrowhead A1 in FIG. 4, i.e. to the front part from the back part of the coin accepting part 52, convey the coin.

Furthermore, the coin discharge 15 is provided with a reversed expansion cylinder 105, a discharge stop gate 106 and a dispensing counting sensor 107, arranged at an outlet of the coin accepting part 52.

The reversed expansion cylinder 105 rotates along with the direction which is as the same as that of the discharge conveyor belts 101, so that the discharge conveyor belts 101 discharge the coins one by one.

The discharge stop gate 106 is opened and closed to be driven by a dispensing solenoid 108, the discharge stop gate 106 waits the coin under a close state, and on the other hand, the discharge conveyor belts 101 are allowed to dispense the coin under an open state.

The dispensing counting sensor 107 detects the coin dispended by the discharge conveyor belts 101.

A coin discharge port 18 is arranged under the terminal position (front end) of the conveying conveyor belt 42 as shown in FIG. 1. The coin discharge port 18 discharges the coin by the discharge conveyor belts 101. As shown in FIG. 2, the coin discharge port 18 is arranged at the left side of a coin charge port 21.

As shown in FIG. 3, the coin depositing and dispensing apparatus 10 carries the CPU 121 taken as an information process part. The CPU 121 is connected with an ROM 122 prestoring fixed data such as a program and the like, and an RAM 123 storing various data by means of free overwrite. The CPU 121, the ROM 122 and the RAM 123 form into a microcomputer.

Furthermore, the CPU 121 is connected with an input port 125 inputting a signal from sensors such as the depositing sensor 31, the counting sensor 87 (87a-87f), the dispensing counting sensor 107, the box sensor 66, the material sensor 62, the diameter sensor 63, the thickness/hole detecting sensor 64 and the like, an output port 126 outputting a driving signal to the reject solenoid 65, the dispensing solenoid 108 and the like, a communication interface electrically connected with a POS terminal, a motor drive control portion 128 independently controlling motor group M such as the depositing motor 32, the conveying motor 70, the dispensing motor 110 and the like, and an operating panel control portion 129 connected with an operating panel 14 to obtain a key signal inputted by operation personal through a system bus 124. Each part is controlled under the drive of the CPU 121 according to the program.

In the structure, if the coin is deposited into the coin charge port 21, the depositing sensors 31 detect the coin. By receiving a detect signal of the depositing sensors 31, the CPU 121 drives the depositing motor 32 and the conveying motor 70, so as to rotate the charge conveyor belt 33, the conveying conveyor belt 42 and the selecting conveyor belt 83. The coin is conveyed to the coin conveying surface 41 due to the rotation of the charge conveyor belt 33. Then, the coin conveyed to the coin conveying surface 41 is conveyed to the downstream side of the coin conveying direction due to the rotation of the conveying conveyor belt 42.

Herein, the conveying conveyor belt 42 carries the side face of the coin on a conveying route of which width is gradually narrowed in the manner of the conveying guiding component 44. Therefore, the coins are conveyed on the coin conveying surface 41 by forming into a same passing track according to the type of the coin.

Furthermore, if the relationship between the angle alpha of the first inclined surface and the angle beta of the second inclined surface is that the angle alpha is greater than the angle beta, so that the coin dispended out of the coin charge port 21 keeps to the side as much as possible by a shorter distance of the conveying guiding component 44 at the upstream side of the coin conveying direction.

Accordingly, the method that the coin is pressed by the conveying guiding component 44 to be conveyed on the coin conveying surface 41 is call as the side-keeping conveying of the coin. The reason that the coin is conveyed by keeping side is as follows. The diameter sensor 63 has to guide the coin to keep the side to be positioned when judging the diameter of coin, so that the coin is judged by the diameter sensor 63. Therefore, the coin dispended out of the coin charge port 21 needs leaning against the coin conveying surface 41 to be positioned when being judged.

The coin which is conveyed by the conveying guiding component 44 on the coin conveying surface 41 passes through the material sensor 62, the thickness/hole detecting sensor 64 and the diameter sensor 63.

The CPU 121 judges the coin based on the output of the material sensor 62, the diameter sensor 63 and the thickness/hole detecting sensor 64. In the case that the conveyed coin is judged to the true coin, the CPU 121 does not control the reject solenoid 65 in a driving way, and the reject stop gate driven by the reject solenoid 65 keeps at a close state. Therefore, the coin is conveyed to the coin selecting part 50 rather being fallen off from the reject hole 33a which is not shown in the figures. On the other hand, in the case that the conveyed coin is judged to the false coin, the CPU 121 controls the reject solenoid 65 in a driving way to keep the reject stop gate at an open state. Accordingly, the coin which is judged to the false coin is fallen off from the reject hole 33a to be accepted in the reject box which is not shown in the figures.

In the coin selecting part 50, the coin is conveyed by the selecting conveyor belt 83, fallen off from the corresponding selecting holes 84, and accepted in the coin accepting part 52. This moment, the selecting conveyor belt 83 and the reference plane 86 are arranged in the manner that the two get more and more adjacent to each other towards the downstream side of the coin conveying direction, so that the selecting conveyor belt 83 presses the side face of the coin on the reference plane 86 and carries the coin.

Furthermore, the CPU 121 drives the discharge conveyor belts 10 in the case that a coin discharge instruction is received from the POS terminal, and drives the dispensing solenoid 108 according to the type of the coin, so as to dispense the coin with necessary number from the coin discharge port 18.

Accordingly, the coin is fallen off from a movable coin bearing surface 24A formed on the surface of a switching component 24, so as to be kept in a tray part 22 of the coin discharge part 15.

Then, the action of embodiments is explained.

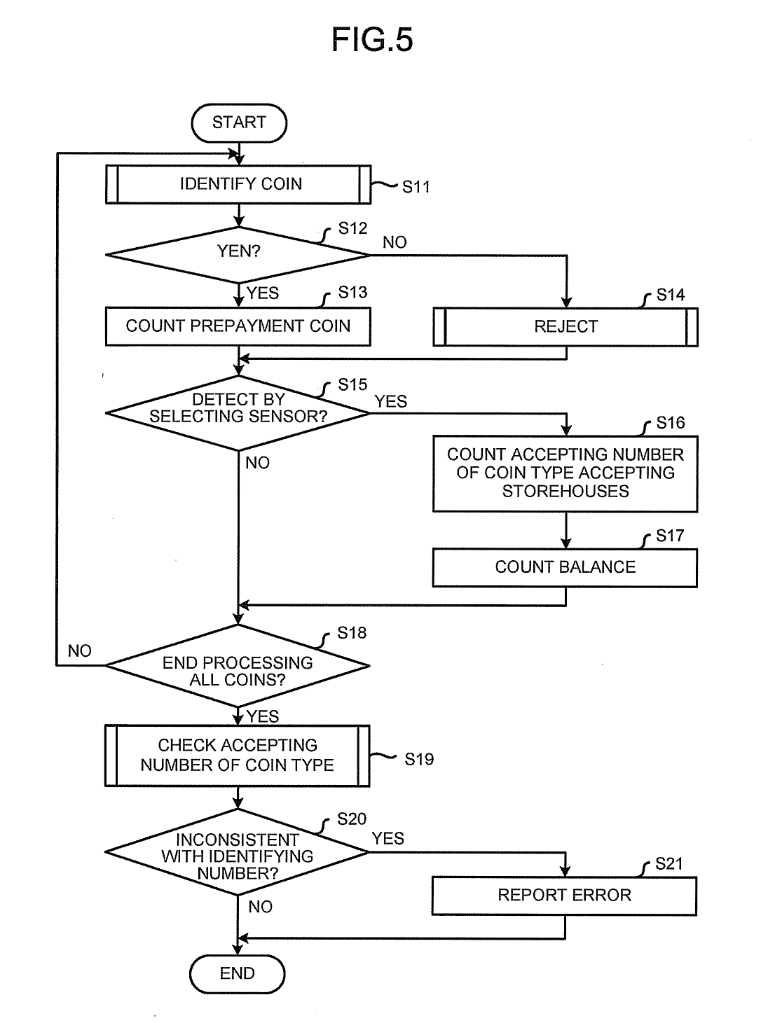

FIG. 5 is a process flowchart of the embodiments.

After the coin is deposited from the coin charge port 21, the CPU 121 identifies the coin by the material sensor 62, the diameter sensor 63 and the thickness/hole detecting sensor 64 (Act S11).

After identifying the coin in the Act S11, judging whether the deposited coin is yen or not (Act S12).

In the judging of the Act S12, in the case that the deposited coin is not the yen (Act 12; No), the coin should not be taken as the pre-accepted coin to be accepted, so that the dispended coin is rejected (Act S14), and the Act S15 is executed.

In the judging of the Act S12, in the case that the deposited coin is the yen (Act 12; Yes), counting the pre-accepted coin based on the type of the coin and the charge number of the identified coin (Act 13). Then, the CPU 121 judges whether counting sensors 87a-87f taken as selecting sensors detect the falling of the coin or not (Act S15).

In the judging of the Act S15, in the case that all counting sensors 87a-87f do not detect the fallen coin (Act S15; No), executing a Act S18.

In the judging of the Act S15, in the case that any counting sensor 87a-87f detects the fallen coin (Act S15; Yes), the CPU 121 counts the accepting number of the coin type accepting storehouses corresponding to the counting sensors which detect the fallen coin (Act S16).

Then, based on a counting result of the counting number, the balance corresponding to the accepting number of all coin type accepting storehouses is counted (Act S17).

Then, the CPU 121 judges whether the process of the all deposited coins is ended or not (Act S18).

In the judging of the Act S18, in the case that the process of all the deposited coins is not ended (Act S18; No), the Act S11 is reprocessed, and the same process is repeated.

In the judging of the Act S18, in the case that the process of all the deposited coins has been ended (Act S18; Yes), checking the coin accepting number according to the type of the coin (Act S19).

After the checking process of the Act S19, judging whether the number is inconsistent with the coin identifying number of the Act S18 , i.e. the identifying number, or not (Act S20).

In the judging of the Act S20, after the checking process of the Act S18, in the case that the number is inconsistent with the coin identifying number of the Act S11, i.e. the identifying number, specifically accepting the inconsistent coin type accepting storehouses, performing an error report of which the content is that the material of the coin is abnormal (Act S21), and ending the process.

Herein, one specific embodiment of the false report is explained.

In the deposited coin, in the case that the 5 yen coin is accepted in the coin type accepting storehouse of 100 yen coin, in the coin identifying process of the Act S11, the deposited coin is identified to be 5 yen coin, but the coin is accepted in the coin type accepting storehouse of 100 yen coin. Accordingly, the CPU 121 reports the false material of the 100 yen coin to be the error report.

In this case, the error that the coin is not enough or the coin is deposited will not be output, so that the state that which type of the deposited coin is deposited in to which type of the coin type accepting storehouse can be avoided, and as long as the coins accepted in the coin type accepting storehouse of 100 yen coin are all recovered, the falsely-accepted 5 yen coin can be recovered.

Furthermore, the recovered 5 yen coin is reserved at the other occasions rather being taken as change, under this state, as long as the 100 yen coins are redeposited into the coin charge port 21, all deposited 100 yen coins will be accepted at the coin type accepting storehouse of the 100 yen coins, so that the exact balance can be counted.

On the other hand, in the judging of the Act S20, after the checking process of the Act S18, in the case that the number is consistent with the coin identifying number of the Act S11, i.e. the identifying number (Act S20; No), if the process is normal process, ending the process.

Accordingly, according to the embodiment, even if the coin is falsely selected and accepted, the balance of the coin depositing and dispensing apparatus also can be simply returned to the normal state.

A control program executed by the coin depositing and dispensing apparatus of the embodiment is recorded in computer-readable record mediums such as CD-ROM, floppy disk (FD), CD-R, DVD (Digital Versatile Disk) and the like by an installable or executable files to be provided.

Furthermore, the control program executed by the coin depositing and dispensing apparatus of the embodiment is stored on the computer connected with the network such as the Internet and the like, and is downloaded by the network to be provided. Furthermore, the control program executed by the coin depositing and dispensing apparatus of the embodiment is provided or issued by the network such as the Internet and the like.

Furthermore, the control program of the coin depositing and dispensing apparatus of the embodiment is further preprogrammed in the ROM and the like to be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A coin depositing and dispensing apparatus, comprising:
a coin selecting unit configured to select the type of the coin by kind according to the shape of the deposited coin;
a plurality of coin type accepting storehouses configured to accept the coin selected by the coin selecting unit according to the type of coin;
an accepting number detecting unit configured to detect the number of the coin accepted in each coin type accepting storehouse; and
a balance counting unit configured to count the balance according to the detecting result by the accepting number detecting unit.

2. The coin depositing and dispensing apparatus according to claim 1, wherein
the accepting number detecting unit include a plurality of accepting detecting units that is arranged in each of the coin type accepting storehouses, so as to detect that the coin type accepting storehouses accept the coin.

3. The coin depositing and dispensing apparatus according to claim 2, further comprising:
a coin type judging unit configured to identify the coin type of the deposited coin; and
a false selecting and accepting judging unit configured to judge that the false selecting and accepting of the coins with different types are accepted in the plurality of coin type accepting storehouses according to a judging result of the type of the coin judging unit and a judging result of the accepting detecting units.

4. The coin depositing and dispensing apparatus according to claim 3, further comprising
a reporting unit configured to report a coin type specifying message according to the judging result of the false selecting and accepting judging unit in case of false selecting and accepting.

5. A control method of the coin depositing and dispensing apparatus, executed by the coin depositing and dispensing apparatus including the coin type accepting storehouses capable of accepting coin according to the coin type, comprising:
selecting the type of the coin by kind according to the shape of the deposited coin;
detecting the number of the coin accepted in each coin type accepting storehouse; and
counting the balance according to the detecting result by the accepting number detecting unit.
